(19) United States
(12) Patent Application Publication
(10) Pub. No.: US 2002/0018472 A1
(43) Pub. Date: Feb. 14, 2002

(54) Radio link protocol with reduced signaling overhead

(76) Inventors: Mikko Rinne, Helsinki (FI); Terhi Virtanen, Oulu (FI)

Correspondence Address: Michael B. Lasky, Altera Law Group, Suite 100, 6500 City West Parkway, Minneapolis, MN, 55344-7701, US

(21) Appl. No.: 09/824,939

(22) Filed: Apr. 3, 2001

Related U.S. Application Data
(63) Continuation of application No. PCT/EP98/06362, filed on Oct. 6, 1998.

(51) Int. Cl. H04L 12/28

(52) U.S. Cl. 370/394; 370/410

(57) ABSTRACT

A signaling method for a link protocol used for transmitting a data unit in a telecommunication system and a network element using the signaling method are described, wherein a predetermined number of a sequence number field provided in a protocol data unit is used for signaling a control function of the link protocol, such as a protocol reset function. Thereby, a separate control PDU-type is no longer required for signaling the respective control function, such that transmission overhead can be reduced.

### FIELD OF THE INVENTION

The present invention relates to signaling method for a link protocol used for transmitting a data unit in a telecommunication system such as the GSM system, and to a network element, transmitter and receiver using the signaling method.

### BACKGROUND OF THE INVENTION

In telecommunication systems, protocol layers are provided in order to define an architecture of a signaling system for exchanging an information. A protocol layer is a logical unit in a communication element such as a mobile station (MS), a base station (BS) or a mobile switching center (MSC). Each protocol layer has specific tasks and means or tools for achieving its tasks.

In the GSM system, a Radio Link Protocol (RLP) is used for data transmission and covers the layer 2 functionality of the ISO OSI Reference Model (IS 7498). The RLP has been tailored to the special needs of digital radio transmission and provides to its users the OSI Data Link Service (IS 8886).

The RLP spans from the MS to an interworking function (IWF) located at the nearest MSC, or beyond. Depending on the exact location of the IWF, handover of the MS may result in a link-reset or even total loss of connection. The RLP is used to balance configuration, employing asynchronous operation, i.e. either station has the right to set-up, reset or disconnect a link at any time. The RLP is full-duplex in the sense that it allows for information to be transferred in both directions simultaneously.

Between the two endpoints of an RLP-connection, there exists a flow control function specified by a queue model, wherein packet data units (PDUs) comprising a protocol header portion and transmission data are placed in a queue for subsequent transmission.

The RLP has a separate set of control PDUs including a reset PDU for signaling a reset of peer entities of the RLP. The control PDU-type is indicated in the header portion of the PDU. The reset PDU is placed in the queue in order to signal a reset. Thus, extra control PDU-types are required for control functions such as resetting an RLP connection.

In upcoming third generation telecommunication systems such as the Universal Mobile Telecommunication System (UMTS), a Radio Link Control (RLC) protocol will be used, which is intended for high data rates. This means that extra overhead for control purposes should be avoided.

However, defining control PDU-types adds overhead to the protocol header and the use of a very high number of control messages adds undesirable complexity in the protocol.

### SUMMARY OF THE INVENTION

It is therefore an object of the present invention to provide a signaling method for a link protocol and a network element using the same, by means of which overhead and complexity can be reduced.

This object is achieved by a signaling method for a link protocol used for transmitting a data unit in a telecommunication system, comprising the steps of:

encapsulating the data unit in a protocol data unit having a field for a sequence number of the data unit; and

using a predetermined sequence number for signaling a control function of the link protocol.

Furthermore, the above object is achieved by a transmitter for transmitting a data unit in a telecommunication system, wherein the transmitted data unit is encapsulated in a protocol data unit having a field for a sequence number, comprising:

signaling transmitting means for signaling a control function; and

sequence numbering means, responsive to said signaling transmitting means, for indicating said control function using said sequence number field.

Additionally, the above object is achieved by a receiver for receiving a data unit in a telecommunication system, wherein the received data unit is encapsulated in a protocol data unit having a field for a sequence number, comprising:

sequence number reading means for reading a sequence number in said sequence number field; and

signaling receiving means, responsive to the sequence number reading means, for interpreting a predefined sequence number as a request for a control function.

Accordingly, a predetermined number in the address space of the data unit sequence number is reserved for signaling a control function of the link protocol. Thereby, a separate control PDU-type is no longer required for signaling the control function, such that the overhead in the PDU header portion can be reduced.

Preferably, the control function is a reset function of the link protocol. Thus, if the reset function is the only control signal needed in the forward direction, a PDU-type indicator would no longer be required.

The predetermined sequence number may be the number “0”. In this case, the sequence numbering of the protocol data units simply can be changed by continuing with the number “1” after the maximum sequence number has been reached. This may easily be achieved by a corresponding sequence counter reset function.

Alternatively, the predetermined sequence number may be one of the numbers having the highest values addressable in the sequence number field. In this case, the sequence numbering of the protocol data units may continue with the number “0” after reaching a maximum number defined to be less than the predetermined sequence number.

### BRIEF DESCRIPTION OF THE DRAWINGS

In the following the present invention will be described in greater detail on the bases of a preferred embodiment with reference to the accompanying drawings in which:

FIG. 1 shows a principle diagram of a queue model used for specifying a flow control function of an RLC connection,

FIG. 2 shows a principle frame structure of an RLC protocol data unit, and

FIG. 3 shows a principle block diagram of a transmitter and a receiver of respective network elements according to the preferred embodiment of the invention.

### DESCRIPTION OF THE PREFERRED EMBODIMENT

The following preferred embodiment relates to a signaling method used in an RLC PDU of the UMTS.

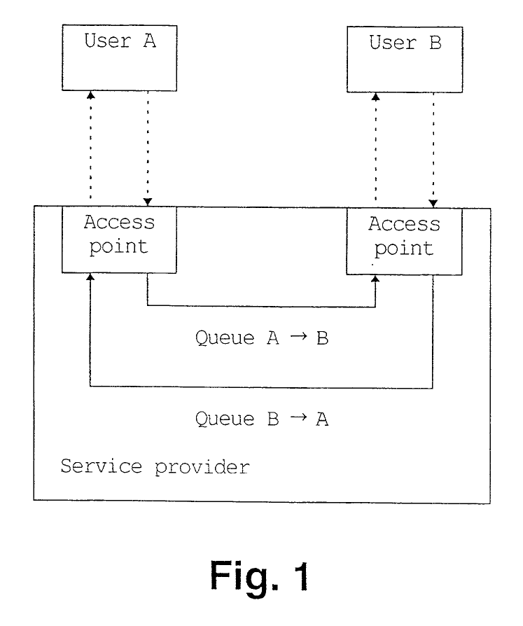

FIG. 1 shows a principle diagram of a queue model specifying a flow control function of an RLC connection. According to FIG. 1, a user A and a user B are connected via access points to a service provider, i.e. the UMTS. The RLC protocol establishes a first queue A→B including data units transmitted from the user A to the user B, and a second queue B→A including data units transmitted from the user B to the user A.

The data units are encapsulated in respective PDUs of the RLC protocol, wherein a sequence of the PDUs in the queue is specified by a sequence number provided in a corresponding field of a header portion of each PDU. Based on the sequence number of the PDUs, a receiver may confirm that all PDUs have been received properly. A maximum number (window size) of outstanding PDUs in the queue at any time is defined by the maximum sequence number. Usually, PDUs are transmitted in numerical order of their sequence number. A normal information transfer is haltet, when the number of outstanding, unacknowledged PDUs is equal to the established window size. The window size, i.e. address space of the sequence number, should be as large as possible to enable an adequate window for efficient transmission.

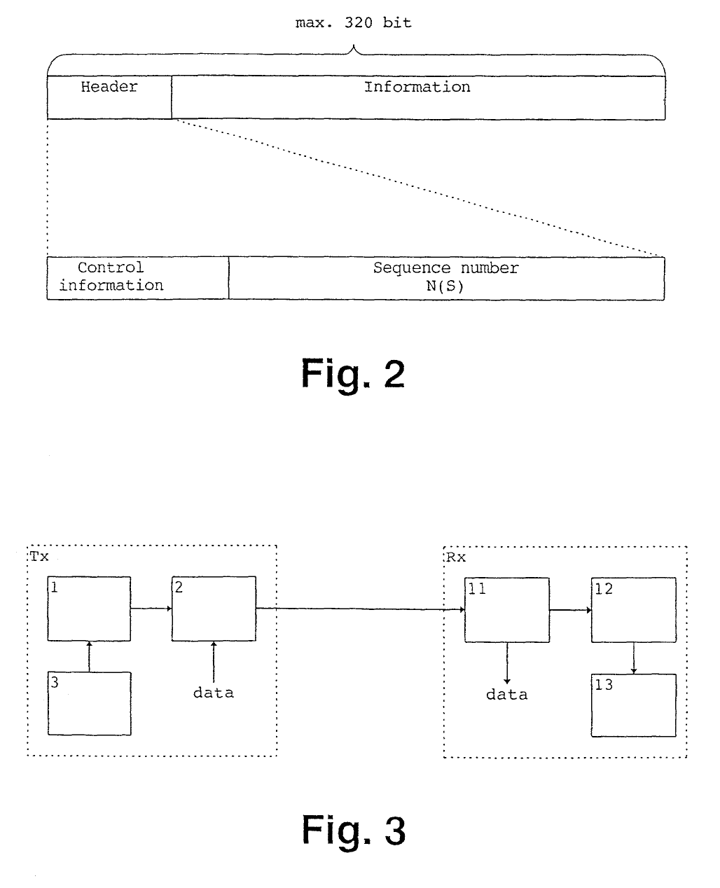

FIG. 2 shows a principle structure of an RLC protocol frame structure of a PDU. RLC frames are sent in strict alignment with the radio transmission and have a maximum size of 320 bits. Whenever such an RLC frame is to be sent, the RLC entity has to provide the necessary protocol information to be contained therein.

According to the upper portion of FIG. 2, the RLC frame basically comprises a header and an information field. As indicated in the lower portion of FIG. 2, the RLC header carries a control information including a sequence number field N(S) which includes a sequence number of the RLC frame.

According to the preferred embodiment, one number of the address space of the sequence number field N(S) is used for signaling a control function such as a protocol reset of the RLC. When such a protocol reset information is issued, the RLC entity has set to zero its internal variables for sending and receiving numbered information. The other RLC entity, when receiving the reset information, will either confirm it by setting to zero its internal variables for sending and receiving numbered information and then issuing an acknowledgement or reject it by sending a corresponding response.

The predetermined number for signaling the protocol reset may be zero. In this case, a predetermined rule for both RLP entities, i.e. the transmitter and the receiver, has to be established, such that the sequence numbering does not follow a strict modulo n rule, when reaching the maximum number. Instead, the transmission continues with the number “1”. The sequence number “0” is dedicated to resetting the link in both the transmitter and the receiver. If a resumed sequence number is needed, it can be defined to be included in the body of the message.

Alternatively, one of the highest sequence numbers addressable in the sequence number field N(S) can be used for signaling the protocol reset. In this case, the sequence numbering is adapted by defining a maximum sequence number which is less than the predetermined sequence number, i.e. less than the total sequence number address space. The sequence numbering is then continued with the number “0”, i.e. the lowest number of the address space, after the defined maximum sequence number has been reached.

Of course, any other sequence number could be dedicated to the resetting function, provided the dedicated sequence number is skipped in the sequence numbering.

If there is no need for other control-PDUs than reset, the invention removes the need for a separate protocol control PDU type, which saves transmission overhead.

Moreover, even a plurality of sequence numbers could be dedicated to respective other control functions, as long as the sequence numbering would be adapted so as to skip the corresponding sequence numbers.

FIG. 3. shows a principle block diagram of a transmitter Tx and a receiver Rx, connected to each other, which may be provided in a network element of the UMTS.

The transmitter Tx comprises a signaling transmitter 1 for signaling a control function such as the reset function of the link protocol. The signaling transmitter 1 is connected to a transmitter control means 3 which controls the signaling transmitter 1 so as to signal a required control function. Furthermore, a sequence number generator 2 is provided, to which data (i.e. PDUs) is supplied from a data generating portion (not shown) and which successively generates the required sequence numbers, incorporates them into the sequence number field N(S) of the header portion of the PDUs and transmits the PDUs to the network element at the other transmission end.

According to the preferred embodiment, the signaling transmitter 1 is connected to the sequence number generator 2 so as to control the sequence number generator 2 in such a manner that the predetermined sequence number indicating a control function is inserted into the sequence number field N(S), when the control function is to be signaled.

The transmitted PDU is transmitted to a sequence number reader 11 provided in a receiver Rx of the network element at the other transmission end. The sequence number reader 11 is arranged to read the sequence number of the received PDU and to supply the data of the PDU to a data receiving portion (not shown) of the receiver Rx. The read sequence number is supplied by the sequence number reader 11 to a signaling receiver 12 which interprets the read sequence number. If the read sequence number corresponds to a predetermined sequence number indicating a control function, the signaling receiver 12 determines a request for this control function and performs a corresponding signaling to a receiver control means 13 so as to initiate the requested control function, such as the protocol reset.

Thus, a control function such as the protocol reset can be signaled to the other network element by inserting the predetermined sequence number.

In summary, a signaling method for a link protocol used for transmitting a data unit in a telecommunication system and a network element is described, wherein a predetermined number of a sequence number field provided in a protocol data unit is used for signaling a control function of the link protocol, such as a protocol reset function. Thereby, a separate control PDU-type is no longer required for signaling the respective control function, such that transmission overhead can be reduced.

It should be understood that the above description and accompanying drawings are only intending to illustrate the present invention. Thus, the signaling method according to the present invention may also be used in other communications systems having a link protocol which defines a sequence number of data units. The preferred embodiment of the invention may vary within the scope of the attached claims.

1. A signaling method for a link protocol used for transmitting a data unit in a telecommunication system, comprising the steps of:
a) encapsulating said data unit in a protocol data unit having a field for a sequence number of said data unit; and
b) using a predetermined sequence number for signaling a control function of said link protocol.

2. A method according to claim 1, wherein said control function is a protocol reset function.

3. A method according to claim 1 or 2, wherein said protocol data unit is an RLC protocol data unit of a UMTS system.

4. A method according to any one of the preceding claims, wherein said predetermined sequence number is the number “0”.

5. A method according to claim 4, wherein a sequence numbering of said protocol data unit is continued with the number “1” after reaching a maximum number.

6. A method according to any one of claims 1 to 3, wherein said predetermined sequence number is one of the numbers having the highest values addressable in said sequence number field.

7. A method according to claim 6, wherein a sequence numbering of said protocol data unit is continued with the number “0” after reaching a maximum number defined to be less than said predetermined sequence number.

8. A communication element using a link protocol for transmitting a data unit in a telecommunication system,
wherein a control function for controlling said communication element is signaled by a signaling method according to any one of claims 1 to 7.

9. A communication element according to claim 8, wherein said communication element is a base station or a radio network controller.

10. A communication element according to claim 8, wherein said communication element is a mobile station.

11. A transmitter for transmitting a data unit in a telecommunication system, wherein the transmitted data unit is encapsulated in a protocol data unit having a field for a sequence number, comprising:
a) signaling transmitting means (1) for signaling a control function; and
b) sequence numbering means (2), responsive to said signaling transmitting means (1), for indicating said control function using said sequence number field.

12. A receiver for receiving a data unit in a telecommunication system, wherein the received data unit is encapsulated in a protocol data unit having a field for a sequence number, comprising:
a) sequence number reading means (11) for reading a sequence number in said sequence number field; and
b) signaling receiving means (12), responsive to the sequence number reading means, for interpreting a predetermined sequence number as a request for a control function.
